(19) United States
(12) Patent Application Publication
(10) Pub. No.: US 2024/0028010 A1
(43) Pub. Date: Jan. 25, 2024

(54) NETWORK RELAY DEVICE

(71) Applicant: FANUC CORPORATION, Minamitsuru-gun, Yamanashi (JP)

(72) Inventors: Nao ONOSE, Yamanashi (JP); Naoya NISHINAGA, Yamanashi (JP)

(21) Appl. No.: 18/025,271

(22) PCT Filed: Sep. 22, 2021
(86) PCT No.: PCT/JP2021/034768

§ 371 Date: Mar. 8, 2023

(30) Foreign Application Priority Data
Sep. 29, 2020 (JP) 2020-163250

(51) Int. Cl. G05B 19/418

(52) U.S. Cl. CPC G05B 19/4185; G05B 19/4183

(57) ABSTRACT

A network relay device that relays communications between industrial machinery and a network on the basis of predefined protocol information. The network relay device comprises a packet analysis unit that analyzes the content of a communication request that is a packet that has been transmitted to the industrial machinery from the network, an information acquisition unit that acquires industrial machinery information from the industrial machinery, the industrial machinery information including at least one of an operating state, configuration information, control information, and environment information for the industrial machinery, a communicability determination unit that determines the communicability of the communication request from the protocol information, the communication request analysis results, and the industrial machinery information, and a communication mediation unit that mediates communication between the industrial machinery and the network from the communicability determination results.

### TECHNICAL FIELD

The present invention relates to a network relay device.

### BACKGROUND ART

There is a known network communication method for performing control and information collection through a network for an industrial machine such as a machine tool or a robot. For example, see Patent Document 1.

The network communication method mentioned above, for example, makes it possible to perform machining and give a machining start command or the like while transferring a machining program to the industrial machine through the network.
Patent Document 1: Japanese Unexamined Patent Application, Publication No. 2016-71407

### DISCLOSURE OF THE INVENTION

### Problems to be Solved by the Invention

Incidentally, services in network communication are generally fixed using port numbers, and commands to be given to an industrial machine are changed by changing data of internal packets (also referred to below as “communication requests”) in the same protocol communication. Denial of communication through a firewall therefore involves denials on a port number-by-port number basis, making switching between permission and denial of individual commands difficult. Detailed settings make it possible to check individual commands. However, it is still difficult to tailor the switching to the state of the industrial machine. For example, it is difficult to perform dynamic communication arbitration control to permit communication only for a specific period of time.

It is therefore desired to control permission or denial of communication of individual communication requests depending on the state of an industrial machine.

### Means for Solving the Problems

A network relay device according to an aspect of the present disclosure is a network relay device for relaying communication between an industrial machine and a network based on predefined protocol information, the network relay device including: a packet analysis unit configured to analyze content of a communication request, which is a packet transmitted from the network to the industrial machine; an information acquisition unit configured to acquire, from the industrial machine, industrial machine information including at least one of operation state, configuration information, control information, or environment information of the industrial machine; a communication permission/denial determination unit configured to determine permission or denial of communication of the communication request based on the industrial machine information, a result of the analysis of the communication request, and the protocol information; and a communication arbitration unit configured to arbitrate the communication between the industrial machine and the network based on a result of the communication permission/denial determination.

### Effects of the Invention

According to the foregoing aspect, it is possible to control permission or denial of communication of individual communication requests depending on the state of the industrial machine.

### BRIEF DESCRIPTION OF THE DRAWINGS

FIG. 1 is a functional block diagram showing an example of a functional configuration of a network relay system according to an embodiment;

FIG. 2A is a diagram showing an example of a process table that is contained in protocol information data and that includes processes assigned to respective I/O addresses;

FIG. 2B is a diagram showing an example of control information acquired by an information acquisition unit from an industrial machine;

FIG. 3 is a flowchart for describing an example of setting processing by a network relay device based on the control information of the industrial machine and a protocol library in the protocol information data;

FIG. 4 is a flowchart for describing an example of relay processing by the network relay device based on the setting processing in FIG. 3;

FIG. 5 is a flowchart for describing an example of the relay processing by the network relay device based on operation state information of the industrial machine;

FIG. 6 is a flowchart for describing an example of the relay processing by the network relay device based on environment information of the industrial machine;

FIG. 7 is a flowchart for describing an example of the relay processing by the network relay device based on configuration information of the industrial machine; and

FIG. 8 is a flowchart for describing an example of the relay processing by the network relay device based on the configuration information and the environment information of the industrial machine.

### PREFERRED MODE FOR CARRYING OUT THE INVENTION

The following describes an embodiment of the present disclosure with reference to the drawings.

### EMBODIMENT

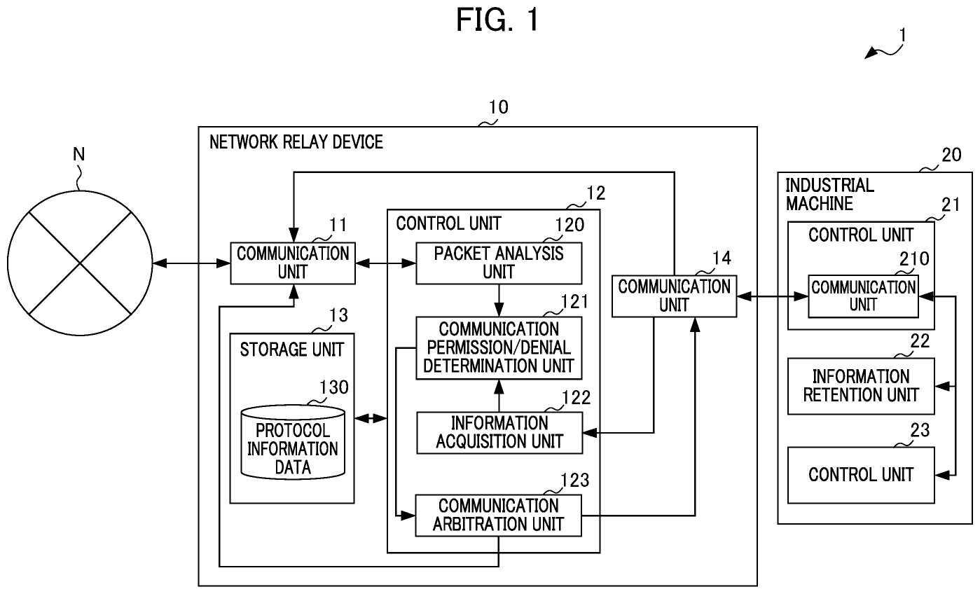

FIG. 1 is a functional block diagram showing an example of a functional configuration of a network relay system according to an embodiment. As shown in FIG. 1, a network relay system 1 includes an industrial machine 20 and a network relay device 10 connected to a network N such as a local area network (LAN) or the Internet.

The network relay device 10 and the industrial machine 20 may be directly connected to each other via a connection interface, not shown. The network relay device 10 and the industrial machine 20 may alternatively be connected to each other via a network, not shown, such as a LAN or the Internet. In this case, as described below, the network relay device 10 and the industrial machine 20 may each have a communication unit for communicating with each other through such a connection.

### <Industrial Machine 20>

The industrial machine 20 is any of various machines known to those skilled in the art, such as a machine tool, an industrial robot, a service robot, a forge rolling machine, or an injection molding machine. As shown in FIG. 1, the industrial machine 20 includes a controller 21, an information retention unit 22, and a control unit 23. The controller 21 includes a communication unit 210.

The controller 21 is, for example, a numerical control device (CNC) or a robot controller known to those skilled in the art. The controller 21 controls, for example, operation of the industrial machine 20 based on a communication request including a machining program or the like received by the network relay device 10 described below via the network N.

The controller 21 is included in the industrial machine 20, but may be independent of the industrial machine 20.

The communication unit 210 performs transmission and reception of data between the controller 21 and the network relay device 10 described below. Specifically, for example, the communication unit 210 receives a communication request for a machining program or the like from the network relay device 10. Conversely, the communication unit 210 transmits, to the network relay device 10, data of a response to the communication request and current industrial machine information of the industrial machine 20. The industrial machine information as used herein refers to, for example, operation state information of the industrial machine 20, configuration information of the industrial machine 20, control information of the industrial machine 20, and environment information of the industrial machine 20.

Specifically, the operation state information of the industrial machine 20 indicates, for example, the current state of the industrial machine 20. Examples of the current state of the industrial machine 20 include a stopped state, a machining state (more specifically, a setting up state, a roughing state, and a finishing state), a warming up state, and an anomalous state.

Examples of the configuration information of the industrial machine 20 include: version of the controller 21 described below that controls the industrial machine 20 (e.g., version of the CNC); type, rated current, rotation number, and torque of a motor (e.g., a spindle motor, a servo motor, or a linear motor), not shown, which is a drive unit included in the industrial machine 20; and tool information indicating a tool attached to the industrial machine 20.

Examples of the control information of the industrial machine 20 include a set of I/O addresses, a set of machining programs, and information regarding control parameters (e.g., rotation number and torque) for the motor, not shown, in the industrial machine 20.

Examples of the environment information of the industrial machine 20 include temperature of the industrial machine 20 itself, loudness (dB) and pitch (Hz) of sound being generated by the industrial machine 20, smell emanating from the industrial machine 20, and vibration being generated by the industrial machine 20.

The information retention unit 22 is, for example, read only memory (ROM), random access memory (RAM), or a hard disk drive (HDD), and retains the current industrial machine information of the industrial machine 20 described above, which is, for example, the operation state information, the configuration information, the control information, and the environment information of the industrial machine 20.

The control unit 23 includes, for example, a central processing unit (CPU), ROM, and RAM. The control unit 23 is a device known to those skilled in the art and performs overall control of the industrial machine 20.

### <Network Relay Device 10>

The network relay device 10 has, for example, a function of receiving, via the network N, a communication request including a machining program or the like from an external device (not shown) such as a computer connected to the network N and transmitting the received communication request to the industrial machine 20, and a function of transmitting, to the external device (not shown), data received from the industrial machine 20 such as a response to the communication request.

The network relay device 10 also transmits and receives data to and from the industrial machine 20. Specifically, for example, the network relay device 10 has a function of transmitting, to the industrial machine 20, a communication request including a machining program or the like received from the external device (not shown) and receiving, from the industrial machine 20, a response to the communication request and/or other data such as the current industrial machine information of the industrial machine 20.

As such, the network relay device 10 includes a communication unit 11, a control unit 12, a storage unit 13, and a communication unit 14 as shown in FIG. 1. The control unit 12 includes a packet analysis unit 120, a communication permission/denial determination unit 121, an information acquisition unit 122, and a communication arbitration unit 123. The storage unit 13 has protocol information data 130.

### <Communication Unit 11>

As described above, the communication unit 11 performs, via the network N, data communication between the network relay device 10 and the external device (not shown) connected to the network N. Specifically, the communication unit 11 receives a communication request including a machining program or the like from the external device (not shown) and, conversely, transmits data received from the industrial machine 20 such as a response to the communication request to the external device (not shown).

### <Communication Unit 14>

As described above, the communication unit 14 performs transmission and reception of data between the network relay device 10 and the industrial machine 20. Specifically, the communication unit 14 transmits a communication request received from the external device (not shown) to the industrial machine 20. Conversely, the communication unit 14 receives data such as a response to the communication request and the current industrial machine information of the industrial machine 20 from the industrial machine 20.

### <Storage Unit 13>

The storage unit 13 is, for example, ROM or an HDD and may store therein the protocol information data 130 as well as various control programs.

The protocol information data 130 is, for example, information data (metadata) that defines conventions (e.g., packet configuration and data format) regarding content of commands in communication requests (packets) to be received from the external device (not shown). Specifically, for example, it is possible to interpret what is specified as a command by data contained in a communication request (packet) by referring to the protocol information data 130. That is, the protocol information data 130 can be described as retaining information that enables interpretation of the purpose of the network communication.

The protocol information data 130 may contain (or retain) information for interpreting content of commands, which is information indicating that a communication request (packet) received through communication means, for example, a request to write to a programmable logic controller (PLC) address or a request to send a machining program.

For example, the value of a portion of a packet is “05” according to an analysis by the packet analysis unit 120 described below, and accordingly the communication permission/denial determination unit 121 described below can determine, for example, that this communication packet requests for communication to write to a PLC address, based on the protocol information data 130.

The protocol information data 130 may also contain (or retain) determination information for determining permission or denial of each communication request.

With the determination information, the communication permission/denial determination unit 121 described below can determine whether or not to permit communication requested through each communication packet by referring to the determination information along the current industrial machine information of the industrial machine 20. The following describes the determination information retained in the protocol information data 130 using examples of various types of industrial machine information (operation state information, configuration information, control information, and environment information of the industrial machine 20).

In a case where the industrial machine information is the operation state information of the industrial machine 20, for example, the protocol information data 130 may contain settings for denying, for example, writing to I/O addresses if the operation state information of the industrial machine 20 indicates a machining state.

In a case where the industrial machine information is the environmental information of the industrial machine 20, for example, the protocol information data 130 may contain a threshold α set as an upper limit of the temperature of the industrial machine 20 (e.g., temperature of the motor (not shown)). The protocol information data 130 may then contain settings for denying, for example, writing to I/O addresses, presuming that the industrial machine 20 is having a problem such as overheating of the motor, not shown, if the temperature of the industrial machine 20 is equal to or greater than the threshold α. Alternatively, the protocol information data 130 may contain a threshold β (β<α) set as a lower limit of the temperature of the industrial machine 20 (e.g., temperature of the motor (not shown)). The protocol information data 130 may then contain settings for denying, for example, a machining start command to prevent machining without a sufficient warm up operation, presuming that the industrial machine 20 has not warmed up sufficiently, if the temperature of the industrial machine 20 is equal to or less than the threshold β.

In another case where the industrial machine information is the environmental information of the industrial machine 20, for example, the protocol information data 130 may contain, for each motor (not shown) in the industrial machine 20, a threshold γ (m/s²) set as an upper limit of the value of vibration (acceleration). The protocol information data 130 may then contain settings for denying communication requests (such as a request to write to an I/O address), presuming that the motor (not shown) is experiencing a problem such as an anomaly, if the value of vibration (acceleration) is equal to or greater than the threshold γ. In this case, the threshold γ depends on the type of the motor included in the industrial machine 20 (i.e., configuration information of the industrial machine 20).

In a case where the industrial machine information is the configuration information of the industrial machine 20, for example, the protocol information data 130 may contain, for each version of the controller 21, a list of processes that are implemented in the version. Thus, it is possible to permit a request for a process that is implemented in the version being used and deny a request for a process that is not implemented in the version being used.

In a case where the industrial machine information is the control information of the industrial machine 20, for example, the protocol information data 130 may contain a list of processes assigned to respective I/O addresses. For example, the network relay device 10 may deny a communication request for a process “write to PLC address” received via the network N if the value of the I/O address to which the process “write to PLC address” is assigned is set to “0”. For another example, the network relay device 10 may permit a communication request for a process “send machining program” received via the network N if the value of the I/O address to which the process “send machining program” is assigned is set to “1”.

It should be noted that the details of each type of industrial machine information are described below.

### <Control Unit 12>

The control unit 12 includes, for example, a CPU, ROM, RAM, complementary metal-oxide-semiconductor (CMOS) memory, which are known to those skilled in the art and are configured to communicate with each other via a bus.

The CPU is a processor that performs overall control of the network relay device 10. The CPU reads a system program and an application program stored in the ROM via the bus, and performs overall control of the network relay device 10 in accordance with the system program and the application program. Thus, the control unit 12 is configured to implement the functions of the packet analysis unit 120, the communication permission/denial determination unit 121, the information acquisition unit 122, and the communication arbitration unit 123 as shown in FIG. 1. The RAM stores therein various types of data such as temporary calculation data and display data. The CMOS memory is backed up by a battery, not shown, and is configured as nonvolatile memory that retains stored information even when the network relay device 10 is turned off.

### <Packet Analysis Unit 120>

The packet analysis unit 120 analyzes, for example, content of a communication request, which is a packet received from the network N, based on a known communication system-appropriate analysis method. The packet analysis unit 120 outputs the result of the analysis of the communication request to the communication permission/denial determination unit 121 described below.

### <Information Acquisition Unit 122>

The information acquisition unit 122 acquires, from the industrial machine 20, the industrial machine information including, for example, the operation state, the configuration information, the control information, or the environment information of the industrial machine 20.

### <Communication Permission/Denial Determination Unit 121>

The communication permission/denial determination unit 121 determines, for example, permission or denial of communication of a communication request received from the external device (not shown) with the industrial machine 20, based on the result of the analysis of the communication request provided by the packet analysis unit 120, the industrial machine information of the industrial machine 20 acquired by the information acquisition unit 122 from the industrial machine 20, and the protocol information data 130. It should be noted that operation of the communication permission/denial determination unit 121 is described below.

### <Communication Arbitration Unit 123>

The communication arbitration unit 123 arbitrates communication between the industrial machine 20 and the network N based on the result of the communication permission/denial determination by the communication permission/denial determination unit 121.

Specifically, for example, the communication arbitration unit 123 receives a communication request from the external device (not shown) and if the result of the communication permission/denial determination by the communication permission/denial determination unit 121 is “permit”, transmits the communication request to the industrial machine 20 via the communication unit 14.

On the other hand, for example, the communication arbitration unit 123 does not transmit the communication request received from the external device (not shown) to the industrial machine 20 if the result of the communication permission/denial determination by the communication permission/denial determination unit 121 is “deny”. In this case, the communication arbitration unit 123 may transmit, via the communication unit 11, a message or the like to the external device (not shown) from which the communication request has been transmitted, stating that the communication request has been denied.

### <Relay Processing by Network Relay Device 10>

The following describes examples of operations related to relay processing by the network relay device 10. Specifically, first, an operation of the communication permission/denial determination unit 121 is described, which is an operation for determining permission or denial of a communication request based on the current industrial machine information of the industrial machine 20 and permission/denial information set for each type of industrial machine information (operation state information, configuration information, control information, and environment information of the industrial machine 20) retained in the protocol information data 130.

The following describes individual cases of the relay processing by the network relay device 10, which are (a) the relay processing based on the control information of the industrial machine 20, (b) the relay processing based on the operation state information of the industrial machine 20, (c) the relay processing based on the environment information of the industrial machine 20, (d) the relay processing based on the configuration information of the industrial machine 20, and (e) the relay processing based on the configuration information and the environment information of the industrial machine 20.

(a) Relay Processing based on Control Information of Industrial Machine 20

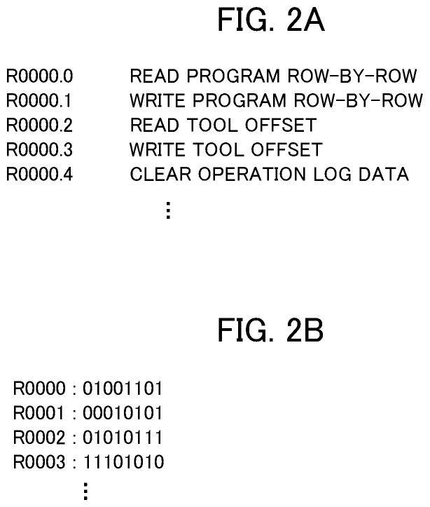

FIG. 2A is a diagram showing an example of a process table that is contained in the protocol information data 130 and that includes processes assigned to respective I/O addresses.

As shown in FIG. 2A, for example, a process “read program row-by-row” is assigned and corresponds to an I/O address “R0000.0”, a process “write program row-by-row” to an I/O address “R0000.1”, a process “read tool offset” to an I/O address “R0000.2”, a process “write tool offset” to an I/O address “R0000.3”, and a process “clear operation log data” to an I/O address “R0000.4” in the process table (also referred to below as “a protocol library”) in the protocol information data 130.

FIG. 2B is a diagram showing an example of the control information acquired by the information acquisition unit 122 from the industrial machine 20. FIG. 2B shows values of the I/O addresses, which are the control information belonging to the industrial machine 20, as an example of the control information acquired by the information acquisition unit 122 from the industrial machine 20.

Specifically, in the case of the control information shown in FIG. 2B, the value of the I/O address “R0000.0” is “1”, which means that the process “read program row-by-row” is set to “permit”. The value of the I/O address “R0000.1” is “0”, which means that the process “write program row-by-row” is set to “deny”. The value of the I/O address “R0000.2” is “1”, which means that the process “read tool offset” is set to “permit”. The value of the I/O address “R0000.3” is “1”, which means that the process “write tool offset” is set to “permit”. The value of the I/O address “R0000.4” is “0”, which means that the process “clear operation log data” is set to “deny”.

The communication permission/denial determination unit 121 sets, for example, permission or denial of communication of communication requests for the process corresponding to a specified I/O address, by determining whether or not a bit of the specified I/O address is set (i.e., the value of the I/O address is “1”) based on the control information indicating the values of the I/O addresses in a given range (e.g., “R0000” to “R0003”) shown in FIG. 2B acquired by the information acquisition unit 122 and the protocol library in the protocol information data 130.

Specifically, as described above, the communication permission/denial determination unit 121 “permits” a communication request for the process “read program row-by-row” since the value of the I/O address “R0000.0” is “1”. The communication permission/denial determination unit 121 “denies” a communication request for the process “write program row-by-row” since the value of the I/O address “R0000.1” is “0”. The communication permission/denial determination unit 121 “permits” a communication request for the process “read tool offset” since the value of the I/O address “R0000.2” is “1”. The communication permission/denial determination unit 121 “permits” a communication request for the process “write tool offset” since the value of the I/O address “R0000.3” is “1”. The communication permission/denial determination unit 121 “denies” a communication request for the process “clear operation log data” since the value of the I/O address “R0000.4” is “0”.

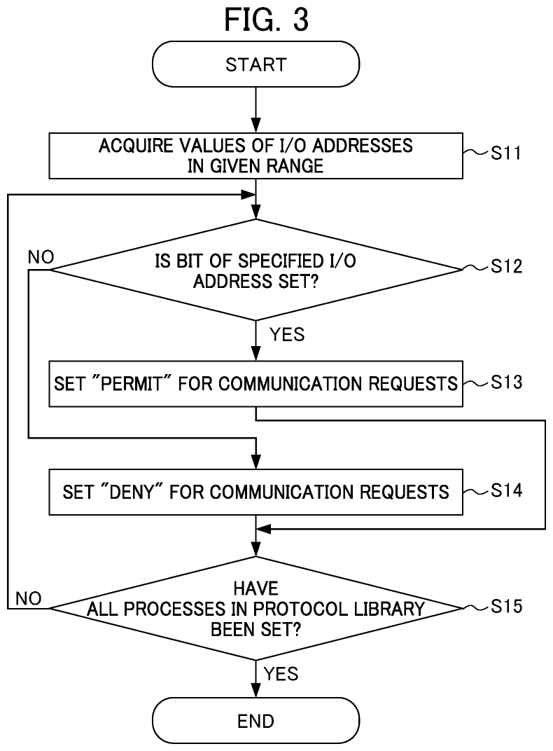

FIG. 3 is a flowchart for describing an example of setting processing by the network relay device 10 based on the control information of the industrial machine 20 and the protocol library in the protocol information data 130.

The following describes an operation in a case where the control information of the industrial machine 20 is the I/O addresses shown in FIG. 2A. However, the same description applies to operations in other cases where the control information of the industrial machine 20 is, for example, a set of machining programs or a set of control parameters for the motor.

In Step S11, the information acquisition unit 122 acquires, from the industrial machine 20, the values of the I/O addresses in a given range as the control information of the industrial machine 20.

In Step S12, the communication permission/denial determination unit 121 determines whether or not the bit of a specified I/O address is set, based on the values of the I/O addresses in the given range acquired in Step S11. If the bit of the specified I/O address is set, that is, if the value of the I/O address is “1”, the processing continues to Step S13. If the bit of the specified I/O address is not set, that is, if the value of the I/O address is “0”, the processing continues to Step S14.

In Step S13, the communication permission/denial determination unit 121 sets “permit” for communication requests for the process assigned to the specified I/O address based on the protocol library in the protocol information data 130.

In Step S14, the communication permission/denial determination unit 121 sets “deny” for communication requests for the process assigned to the specified I/O address based on the protocol information data 130.

In Step S15, the communication permission/denial determination unit 121 determines whether or not all the processes in the protocol library in the protocol information data 130 have been set. If not all the processes in the protocol library have been set, the processing returns to Step S12. If all the processes in the protocol library have been set, the setting processing ends.

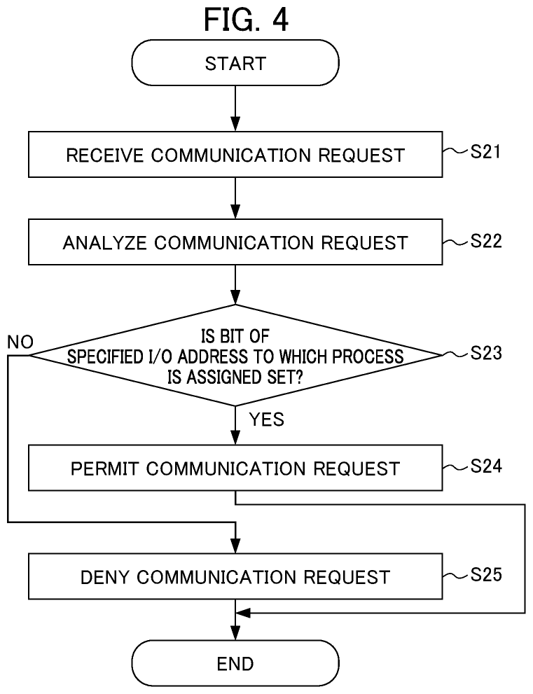

FIG. 4 is a flowchart for describing an example of the relay processing by the network relay device 10 based on the setting processing in FIG. 3. The flow shown in FIG. 4 is performed each time a communication request is received from the external device (not shown).

In Step S21, the communication unit 11 receives a communication request for a process to write to an I/O address, for example, from the external device (not shown) via the network N.

In Step 322, the packet analysis unit 120 analyzes the communication request received in Step S21.

In Step S23, the communication permission/denial determination unit 121 determines whether or not the bit of the specified I/O address to which the process included in the communication request received in Step S21 is assigned is set, based on the control information of the industrial machine 20 acquired in the setting processing in FIG. 3, the result of the analysis by the packet analysis unit 120, and the protocol information data 130. If the bit of the specified I/O address to which the process is assigned is set, the processing continues to Step S24. If the bit of the specified I/O address to which the process is assigned is not set, the processing continues to Step S25.

In Step S24, the communication permission/denial determination unit 121 permits the communication request received in Step S21. Accordingly, the communication arbitration unit 123 transmits the communication request to the industrial machine 20 via the communication unit 14.

In Step S25, the communication permission/denial determination unit 121 denies the communication request received in Step S21. Accordingly, the communication arbitration unit 123 transmits, via the communication unit 11, a message or the like to the external device (not shown) from which the communication request has been transmitted, stating that the communication request has been denied.

(b) Relay Processing based on Operation State Information of Industrial Machine 20

The communication permission/denial determination unit 121 may determine, for example, permission or denial of communication of a communication request received from the external device (not shown) based on the operation state information of the industrial machine 20, which indicates the current state of the industrial machine 20 such as a machining state, acquired by the information acquisition unit 122, the result of the analysis by the packet analysis unit 120, and the protocol information data 130.

Specifically, for example, the communication permission/denial determination unit 121 may deny the communication request if the operation state information of the industrial machine 20 acquired by the information acquisition unit 122 indicates a machining state and the process included in the communication request analyzed by the packet analysis unit 120 is a process to write to an I/O address, for example. On the other hand, the communication permission/denial determination unit 121 may permit the communication request if the process included in the communication request analyzed by the packet analysis unit 120 is a process to write to an I/O address, for example.

Thus, the network relay device 10 can dynamically arbitrate communication depending on the operation state information of the industrial machine 20 and prevent unconsidered commands from being sent to the industrial machine 20, increasing the security.

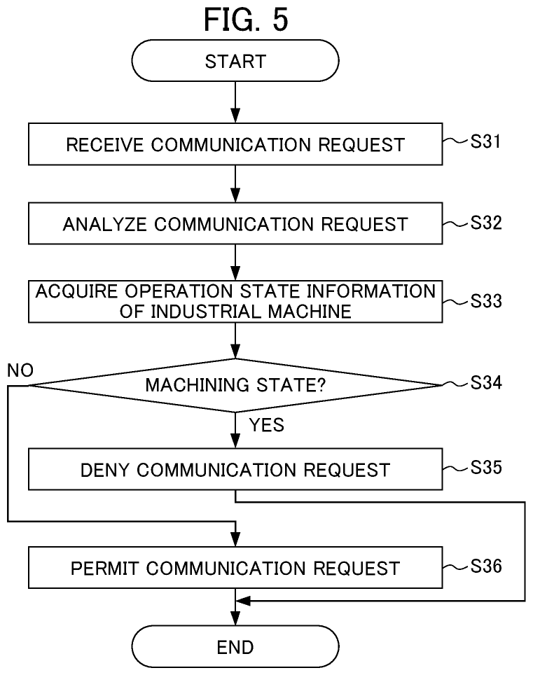

FIG. 5 is a flowchart for describing an example of the relay processing by the network relay device 10 based on the operation state information of the industrial machine 20. The flow shown in FIG. 5 is performed each time a communication request is received from the external device (not shown).

The following describes an operation of the network relay device 10 in a case where the communication permission/denial determination unit 121 determines whether or not the current state of the industrial machine 20 in the operation state information of the industrial machine 20 is a machining state. However, the same description applies to other cases where the current state of the industrial machine 20 is, for example, a stopped state, a setting up state, a roughing state, a finishing state, a warming up state, or an anomalous state.

The processes in Step S31 and Step S32 are the same as those in Step S21 and Step S22 in FIG. 4, and description thereof is omitted.

In Step S33, the information acquisition unit 122 acquires the operation state information of the industrial machine 20.

In Step S34, the communication permission/denial determination unit 121 determines whether or not the current state of the industrial machine 20 is a machining state based on the operation state information of the industrial machine 20 acquired in Step S33. If the current state is a machining state, the processing continues to Step S35. If the current state is not a machining state, the processing continues to Step S36.

In Step S35, the communication permission/denial determination unit 121 denies the communication request. Accordingly, the communication arbitration unit 123 transmits, via the communication unit 11, a message or the like to the external device (not shown) from which the communication request has been transmitted, stating that the communication request has been denied.

In Step S36, the communication permission/denial determination unit 121 permits the communication request. Accordingly, the communication arbitration unit 123 transmits the communication request to the industrial machine 20 via the communication unit 14.

(c) Relay Processing based on Environment Information of Industrial Machine 20

The communication permission/denial determination unit 121 may determine, for example, permission or denial of communication of a communication request received from the external device (not shown) based on the environment information of the industrial machine 20 acquired by the information acquisition unit 122, the result of the analysis by the packet analysis unit 120, and the protocol information data 130.

Specifically, for example, the communication permission/denial determination unit 121 may deny a communication request for a process to write to an I/O address, for example, presuming that the industrial machine 20 is having a problem such as overheating of the motor, not shown, if the temperature of the industrial machine 20 is equal to or greater than the threshold α in the environment information of the industrial machine 20 acquired by the information acquisition unit 122.

Furthermore, for example, the communication permission/denial determination unit 121 may deny a communication request including, for example, a machining start command to prevent machining without a sufficient warm up operation, presuming that the industrial machine 20 has not warmed up sufficiently, if the temperature of the industrial machine 20 in the environment information of the industrial machine 20 acquired by the information acquisition unit 122 is equal to or less than the threshold 3.

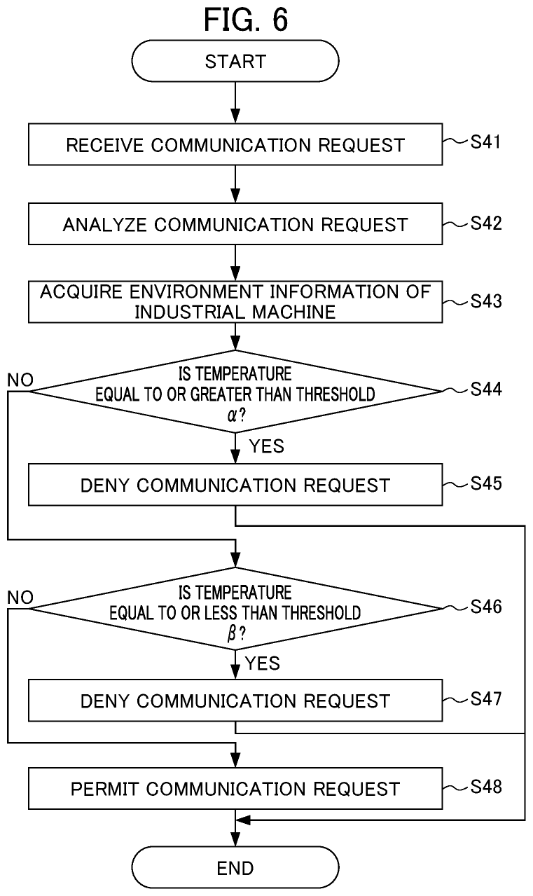

FIG. 6 is a flowchart for describing an example of the relay processing by the network relay device 10 based on the environment information of the industrial machine 20. The flow shown in FIG. 6 is performed each time a communication request is received from the external device (not shown).

The following describes an operation in a case where the environment information of the industrial machine 20 is the temperature of the industrial machine 20. However, the same description applies to other cases where the environment information of the industrial machine 20 is, for example, sound being generated by the industrial machine 20, smell emanating from the industrial machine 20, or vibration being generated by the industrial machine 20.

The processes in Step S41 and Step S42 are the same as those in Step S21 and Step S22 in FIG. 4, and description thereof is omitted.

In Step S43, the information acquisition unit 122 acquires the environment information of the industrial machine 20.

In Step S44, the communication permission/denial determination unit 121 determines whether or not the temperature of the industrial machine 20 is equal to or greater than the threshold α in the environment information of the industrial machine 20 acquired in Step S43. If the temperature of the industrial machine 20 is equal to or greater than the threshold a, the processing continues to Step S45. If the temperature of the industrial machine 20 is less than the threshold α, the processing continues to Step S46.

In Step S45, the communication permission/denial determination unit 121 denies the communication request, presuming that the industrial machine 20 is having a problem such as overheating of the motor (not shown). Accordingly, the communication arbitration unit 123 transmits, via the communication unit 11, a message or the like to the external device (not shown) from which the communication request has been transmitted, stating that the communication request has been denied.

In Step S46, the communication permission/denial determination unit 121 determines whether or not the temperature of the industrial machine 20 is equal to or less than the threshold β. If the temperature of the industrial machine 20 is equal to or less than the threshold β, the processing continues to Step S47. If the temperature of the industrial machine 20 is greater than the threshold β, the processing continues to Step S48.

In Step S47, the communication permission/denial determination unit 121 denies the communication request, presuming that the industrial machine 20 has not warmed up sufficiently. Accordingly, the communication arbitration unit 123 transmits, via the communication unit 11, a message or the like to the external device (not shown) from which the communication request has been transmitted, stating that the communication request has been denied.

In Step S48, the communication permission/denial determination unit 121 permits the communication request. Accordingly, the communication arbitration unit 123 transmits the communication request to the industrial machine 20 via the communication unit 14.

(d) Relay Processing based on Configuration Information of Industrial Machine 20

The communication permission/denial determination unit 121 may determine, for example, permission or denial of communication of a communication request received from the external device (not shown) based on the configuration information of the industrial machine 20 acquired by the information acquisition unit 122, the result of the analysis by the packet analysis unit 120, and the protocol information data 130.

Specifically, for example, the communication permission/denial determination unit 121 may determine whether or not the industrial machine 20 can perform a process included in a communication request, based on the version of the controller 21 in the configuration information of the industrial machine 20 acquired by the information acquisition unit 122, what process is included in the communication request analyzed by the packet analysis unit 120, and the protocol information data 130. The communication permission/denial determination unit 121 may then permit the communication request upon determining that the industrial machine 20 can perform the process included in the communication request, and deny the communication request upon determining that the industrial machine 20 cannot perform the process included in the communication request.

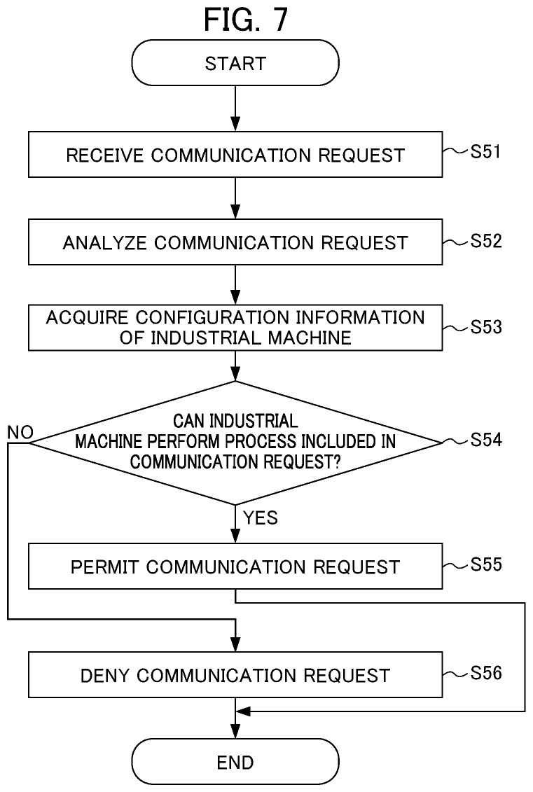

FIG. 7 is a flowchart for describing an example of the relay processing by the network relay device 10 based on the configuration information of the industrial machine 20. The process shown in FIG. 7 is performed each time a communication request is received from the network N.

The following describes an operation in a case where the configuration information of the industrial machine 20 is version of the controller 21. However, the same description applies to other cases where the configuration information of the industrial machine 20 is, for example, type, rated current, rotation number, or torque of the motor (e.g., a spindle motor, a servo motor, or a linear motor) serving as a drive unit of the industrial machine 20, or tool information indicating a tool attached to the industrial machine 20.

The processes in Step S51 and Step S52 are the same as those in Step S21 and Step S22 in FIG. 4, and description thereof is omitted.

In Step S53, the information acquisition unit 122 acquires the configuration information of the industrial machine 20.

In Step S54, the communication permission/denial determination unit 121 determines whether or not the industrial machine 20 can perform the process included in the communication request received in Step S51, based on the version of the controller 21 in the configuration information of the industrial machine 20 acquired in Step S53. If the industrial machine 20 can perform the process included in the communication request, the processing continues to Step S55. If the industrial machine 20 cannot perform the process included in the communication request, the processing continues to Step S56.

In Step S55, the communication permission/denial determination unit 121 permits the communication request. Accordingly, the communication arbitration unit 123 transmits the communication request to the industrial machine 20 via the communication unit 14.

In Step S56, the communication permission/denial determination unit 121 denies the communication request. Accordingly, the communication arbitration unit 123 transmits, via the communication unit 11, a message or the like to the external device (not shown) from which the communication request has been transmitted, stating that the communication request has been denied.

(e) Relay Processing based on Configuration Information and Environment Information of Industrial Machine 20

The communication permission/denial determination unit 121 may determine, for example, permission or denial of communication of a communication request received from the external device (not shown) based on the configuration information and the environment information of the industrial machine 20 acquired by the information acquisition unit 122, the result of the analysis by the packet analysis unit 120, and the protocol information data 130.

Specifically, if the motor (not shown) in the industrial machine 20 is a “motor A” in the configuration information of the industrial machine 20 acquired by the information acquisition unit 122 and if the value of vibration of the “motor A” is equal to or greater than the threshold γ in the environment information, for example, the communication permission/denial determination unit 121 presumes that the “motor A” is experiencing an anomaly. In this case, the communication permission/denial determination unit 121 may deny a communication request for a process to write to an I/O address, for example. On the other hand, if the motor (not shown) in the industrial machine 20 is the “motor A” in the configuration information of the industrial machine 20 acquired by the information acquisition unit 122 and if the value of vibration of the “motor A” is less than the threshold γ in the environment information, the communication permission/denial determination unit 121 presumes that the “motor A” is normal. In this case, the communication permission/denial determination unit 121 may permit the communication request for a process to write to an I/O address, for example.

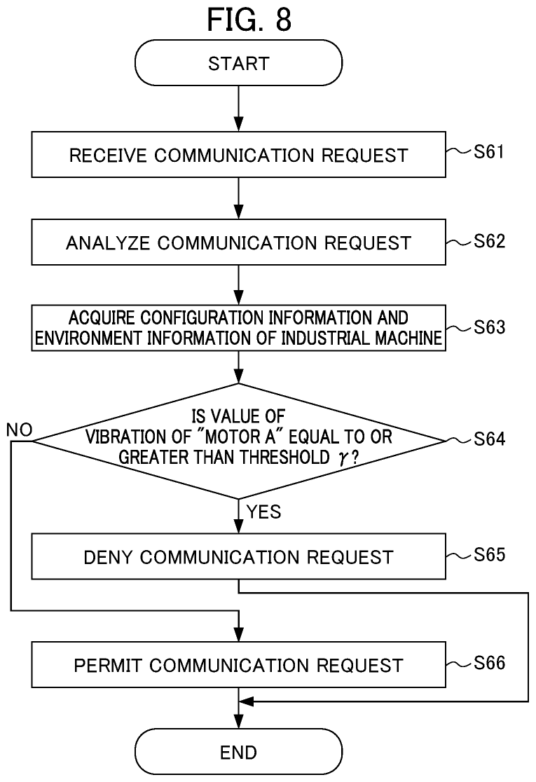

FIG. 8 is a flowchart for describing an example of the relay processing by the network relay device 10 based on the configuration information and the environment information of the industrial machine 20. The flow shown in FIG. 8 is performed each time a communication request is received from the network N.

The following describes an operation in a case where the motor (not shown) in the configuration information of the industrial machine 20 is the “motor A”, and the environment information of the industrial machine 20 is the value of vibration (acceleration) of the “motor A”. However, the same description applies to other cases where the motor (not shown) in the configuration information of the industrial machine 20 is a “motor B”, for example, and the environment information of the industrial machine 20 is the value of vibration of the “motor B”, for example.

The processes in Step S61 and Step S62 are the same as those in Step S21 and Step S22 in FIG. 4, and description thereof is omitted.

In Step S63, the information acquisition unit 122 acquires the configuration information and the environment information of the industrial machine 20.

In Step S64, the communication permission/denial determination unit 121 determines whether or not the value of vibration of the “motor A” in the industrial machine 20 acquired in Step S63 is equal to or greater than the threshold γ. If the value of vibration of the “motor A” is equal to or greater than the threshold γ, the processing continues to Step S65. If the value of vibration of the “motor A” is less than the threshold γ, the processing continues to Step S66.

In Step S65, the communication permission/denial determination unit 121 denies the communication request, presuming that the “motor A” in the industrial machine 20 is experiencing an anomaly. Accordingly, the communication arbitration unit 123 transmits, via the communication unit 11, a message or the like to the external device (not shown) from which the communication request has been transmitted, stating that the communication request has been denied.

In Step S66, the communication permission/denial determination unit 121 permits the communication request, presuming that the “motor A” in the industrial machine 20 is normal. Accordingly, the communication arbitration unit 123 transmits the communication request to the industrial machine 20 via the communication unit 14.

As described above, the network relay device 10 according to the foregoing embodiment determines permission or denial of communication of a communication request received from the external device (not shown) based on the result of the analysis of the communication request, the protocol information data 130, and the industrial machine information acquired from the industrial machine 20 such as the operation state, the configuration information, the control information, or the environment information. Thus, the network relay device 10 can control permission or denial of communication of individual communication requests depending on the state of the industrial machine 20 and arbitrate the communication based on various information belonging to the industrial machine 20.

The network relay device 10 can also allow for a reduction in the communication load of the industrial machine 20 by making settings to permit only a specific communication request only during a period of time that meets specific conditions.

The network relay device 10 can also allow for an increase in the security, because unconsidered commands are prevented from being sent to the industrial machine 20 while the industrial machine 20 is in a machining state, for example.

Although an embodiment has been described above, the network relay device 10 is not limited to the embodiment described above, and encompasses changes such as modifications and improvements to the extent that the intended object is achieved.

### Modification Example 1

In the embodiment described above, the network relay device 10 determines permission or denial of communication of a communication request based on the result of the analysis of the communication request by the packet analysis unit 120, the protocol information data 130, and one of the operation state, the configuration information, the control information, and the environment information as the industrial machine information, or a combination of the configuration information and the environment information. However, the network relay device 10 is not limited as such. For example, the network relay device 10 may determine permission or denial of communication of a communication request based on the result of the analysis of the communication request by the packet analysis unit 120, the protocol information data 130, and a combination of two or more of the operation state, the configuration information, the control information, and the environment information as the industrial machine information.

For example, in a case where the industrial machine 20 is an electric injection molding machine, the network relay device 10 may deny a communication request for the process “write tool offset” even if the bit of the I/O address “R0000.3” for “write tool offset” is set in the control information of the industrial machine 20 that is an electric injection molding machine. This is because the electric injection molding machine does not have a tool, and the configuration information of the industrial machine 20 does not include tool information.

For a warm up operation of the industrial machine 20, for example, it is necessary to cause the industrial machine 20 to perform machining. When receiving a communication request for a machining start command, therefore, the network relay device 10 may transmit the communication request to the industrial machine 20 to cause the industrial machine 20 to start machining for the warm up operation, by permitting the communication request for the machining start command as long as the bit of an I/O address for the warm up operation among the I/O addresses in the control information is set, although the network relay device 10 is supposed to deny the communication request for the machining start command because the temperature of the industrial machine 20 is equal to or less than the threshold (in the environment information.

### Modification Example 2

For another example, in the foregoing embodiment, the protocol information data 130 contains (or retains) the determination information for determining permission or denial of each communication request according to the industrial machine information (operation state information, configuration information, control information, and environment information of the industrial machine 20), as well as the information data (metadata) that defines conventions (e.g., packet configuration and data format) regarding content of commands in communication requests (packets) to be received from the external device (not shown). However, the protocol information data 130 is not limited as such.

For example, the protocol information data 130 may only contain (or retain) the information data (metadata) that defines conventions (for example, packet configuration and data format) regarding content of commands in communication requests (packets) to be received from the external device (not shown). The determination information for determining permission or denial of each communication request depending on the industrial machine information (operation state information, configuration information, control information, and environment information of the industrial machine 20) may be contained (or retained) as a different data set than the protocol information data 130 in the storage unit 13.

Each of the functions included in the network relay device 10 according to the foregoing embodiment can be implemented by hardware, software, or a combination thereof. Being implemented by software herein means being implemented through a computer reading and executing a program.

The program can be supplied to the computer by being stored on any of various types of non-transitory computer readable media. The non-transitory computer readable media include various types of tangible storage media. Examples of non-transitory computer readable media include magnetic storage media (such as flexible disks, magnetic tape, and hard disk drives), magneto-optical storage media (such as magneto-optical disks), compact disc read only memory (CD-ROM), compact disc recordable (CD-R), compact disc rewritable (CD-R/W), and semiconductor memory (such as mask ROM, programmable ROM (PROM), erasable PROM (EPROM), flash ROM, and RAM). Alternatively, the program may be supplied to the computer using any of various types of transitory computer readable media. Examples of transitory computer readable media include electrical signals, optical signals, and electromagnetic waves. Such transitory computer readable media are able to supply the program to the computer through a wireless communication channel or a wired communication channel such as electrical wires or optical fibers.

It should be noted that writing the program to be recorded on a storage medium includes processes that are not necessarily performed chronologically and that may be performed in parallel or individually as well as processes that are performed chronologically according to the order thereof.

To put the foregoing into other words, the network relay device according to the present disclosure can take various embodiments having the following configurations.
(1) A network relay device 10 according to the present disclosure is a network relay device for relaying communication between an industrial machine 20 and a network N based on predefined protocol information data 130, the network relay device including: a packet analysis unit 120 configured to analyze content of a communication request, which is a packet transmitted from the network N to the industrial machine; an information acquisition unit 122 configured to acquire, from the industrial machine 20, industrial machine information including at least one of operation state, configuration information, control information, or environment information of the industrial machine 20; a communication permission/denial determination unit 121 configured to determine permission or denial of communication of the communication request based on the industrial machine information, a result of the analysis of the communication request, and the protocol information data 130; and a communication arbitration unit 123 configured to arbitrate the communication between the industrial machine 20 and the network N based on a result of the communication permission/denial determination.

According to the network relay device 10, it is possible to control permission or denial of communication of individual communication requests depending on the state of the industrial machine 20.
(2) In the network relay device 10 described in (1), the operation state of the industrial machine 20 may be at least one of a stopped state, a machining state, a setting up state, a roughing state, a finishing state, a warming up state, or an anomalous state of the industrial machine 20.

Such a configuration enables the network relay device 10 to control permission or denial of communication of individual communication requests depending on the operation state of the industrial machine 20.
(3) In the network relay device 10 described in (1) or (2), the configuration information of the industrial machine 20 may include at least one of version of a controller 21 that controls the industrial machine 20, type of a drive unit included in the industrial machine 20, or tool information regarding a tool attached to the industrial machine 20.

Such a configuration enables the network relay device 10 to control permission or denial of communication of individual communication requests depending on the configuration of the industrial machine 20.
(4) In the network relay device 10 described in any one of (1) to (3), the control information of the industrial machine 20 may include at least one of a set of I/O addresses, a set of machining programs, or information regarding control parameters for a drive unit included in the industrial machine 20.

Such a configuration enables the network relay device 10 to control permission or denial of communication of individual communication requests depending on the control state of the industrial machine 20.
(5) In the network relay device 10 described in any one of (1) to (4), the environment information of the industrial machine 20 may include at least one of temperature of the industrial machine 20, sound being generated by the industrial machine, smell from the industrial machine, or vibration of the industrial machine 20.

Such a configuration enables the network relay device 10 to control permission or denial of communication of individual communication requests depending on the environment of the industrial machine 20.

### EXPLANATION OF REFERENCE NUMERALS

1: Network relay system
10: Network relay device
11, 14, 210: Communication unit
12, 23: Control unit
120: Packet analysis unit
121: Communication permission/denial determination unit
122: Information acquisition unit
123: Communication arbitration unit
13: Storage unit
130: Protocol information data
20: Industrial machine
21: Controller
22: Information retention unit
N: Network

1. A network relay device for relaying communication between an industrial machine and a network based on predefined protocol information, the network relay device comprising:
a packet analysis unit configured to analyze content of a communication request, which is a packet transmitted from the network to the industrial machine;
an information acquisition unit configured to acquire, from the industrial machine, industrial machine information including at least one of operation state, configuration information, control information, or environment information of the industrial machine;
a communication permission/denial determination unit configured to determine permission or denial of communication of the communication request based on the industrial machine information, a result of the analysis of the communication request, and the protocol information; and
a communication arbitration unit configured to arbitrate the communication between the industrial machine and the network based on a result of the communication permission/denial determination.

2. The network relay device according to claim 1, wherein
the operation state of the industrial machine is at least one of a stopped state, a machining state, a setting up state, a roughing state, a finishing state, a warming up state, or an anomalous state of the industrial machine.

3. The network relay device according to claim 1, wherein
the configuration information of the industrial machine includes at least one of version of a controller that controls the industrial machine, type of a drive unit included in the industrial machine, or tool information regarding a tool attached to the industrial machine.

4. The network relay device according to claim 1, wherein
the control information of the industrial machine includes at least one of a set of I/O addresses, a set of machining programs, or information regarding control parameters for a drive unit included in the industrial machine.

5. The network relay device according to claim 1, wherein
the environment information of the industrial machine includes at least one of temperature of the industrial machine, sound being generated by the industrial machine, smell from the industrial machine, or vibration of the industrial machine.
